(19) United States
(12) Patent Application Publication
(10) Pub. No.: US 2008/0080099 A1
(43) Pub. Date: Apr. 3, 2008

(54) Magnetic head and method of producing the same

(75) Inventor: Masanori Akie, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/652,978

(22) Filed: Jan. 10, 2007

(30) Foreign Application Priority Data
Sep. 28, 2006 (JP) 2006-263699

(51) Int. Cl. G11B 5/33

(52) U.S. Cl. 360/319

(57) ABSTRACT

The magnetic head is capable of effectively applying a bias magnetic field of a hard magnetic layer to the read-head so as to improve and stabilize detection performance. The magnetic head of the present invention comprises: a lower shielding layer; a read-element being formed on the lower shielding layer; an insulating layer continuously coating side faces of the read-element a surface of the lower shielding layer; a base layer being formed on the insulating layer; and a hard magnetic layer being formed on the base layer. Parts of the insulating layer, which coat the side faces of the read-element, are coated with no base layer.

### BACKGROUND OF THE INVENTION

The present invention relates to a magnetic head and a method of producing the magnetic head, more precisely relates to a magnetic head, which includes a CPP (current perpendicular to the plane) type read-head and is characterized by arrangement of a hard magnetic layer, and a method of producing the magnetic head.

FIG. 6 is a sectional view of a conventional magnetic head, which includes a CPP type read-head, seen from an air bearing surface side. In the CPP type read-head, a sensing current runs in a thickness direction (a film layering direction) of the read-element 10 so as to read magnetic data. Therefore, side faces of the read-element 10 and a surface of a lower shielding layer 18, on which the read-element 10 is formed, are coated with insulating layers 12, e.g., alumina.

Hard magnetic layers 14 are formed on the both sides of the read-element 10. The hard magnetic layers 14 apply magnetic fields to a free layer of the read-element 10 so as to stabilize a magnetic domain of the free layer. The hard magnetic layers 14 are made of a magnetic material having a large coercive force, e.g., CoCrPt, CoPt.

The hard magnetic layers 14 are magnetized in the horizontal direction, which is parallel to a plane direction of the free layer of the read-element 10. Conventionally, to magnetize the hard magnetic layers 14 in the horizontal direction, the hard magnetic layers 14 are formed by forming base layers 16 on surfaces of the insulating layers 12 and respectively forming the hard magnetic layers 14 on the base layers 16. The base layers 16 are formed so as to crystal-grow the hard magnetic layers 14 and orient the magnetizing directions thereof in the horizontal direction. Conventionally, the base layers 16 are made of Cr, CrTi, etc.

The conventional magnetic head is disclosed in, for example, Japanese Patent Gazettes No. 2004-152334 and No. 2004-303309.

As described above, in the magnetic head including the CPP type read-head, the side faces of the read-element 10 are coated with the insulating films 12, the surfaces of the insulating films 12 are coated with the base layers 16, and the hard magnetic layers 14 are formed on the base layers 16. In comparison with a CIP (Current In Plane) type read-head, in which the hard magnetic layers directly contact the read-element, intensities of bias magnetic fields, which are generated by the hard magnetic layers 14 and applied to the read-element 10, are reduced by thicknesses of the insulating layers 12 and the base layers 16.

The hard magnetic layers 14 stabilize the magnetic domain of the free layer of the read-element 10. If the bias magnetic fields of the hard magnetic layers 14 are not suitably applied to the read-element 10, detection performance of the read-head will be worse.

To suitably apply the bias magnetic fields of the hard magnetic layers 14 to the read-element 10, the hard magnetic layers 14 may be made of a material having a great coercive force, or the insulating layers 12 may be thinner. However, ferromagnetic materials used for forming the hard magnetic layers 14 are limited; and if the insulating layers 12 are too thin, their electric insulation performance will be lost, so thinning the insulating layers 12 is also limited.

### SUMMARY OF THE INVENTION

The present invention was conceived to solve the above described problems.

An object of the present invention is to provide a magnetic head including a CPP type read-head, which is capable of effectively applying a bias magnetic field of a hard magnetic layer to the read-head so as to improve and stabilize detection performance.

Another object is to provide a method of producing said magnetic head.

To achieve the objects, the present invention has following structures.

Namely, the magnetic head of the present invention comprises: a lower shielding layer; a read-element being formed on the lower shielding layer; an insulating layer continuously coating side faces of the read-element a surface of the lower shielding layer; a base layer being formed on the insulating layer; and a hard magnetic layer being formed on the base layer, and characterized in that parts of the insulating layer, which coat the side faces of the read-element, are coated with no base layer.

In the magnetic head, the base layer may be made of a material, which crystal-grows the hard magnetic layer so as to orient a magnetizing direction of the hard magnetic layer parallel to a surface of the base layer. With this structure, the hard magnetic layer is capable of effectively applying a bias magnetic field to the read-element.

Next, the method of producing the magnetic head comprises the steps of: forming a lower shielding layer on a substrate; forming a read-element on the lower shielding layer, forming an insulating layer to continuously coat side faces of the read-element and a surface of the shielding layer; forming a base layer on the insulating layer; removing parts of the base layer, which correspond to the side faces of the read-element, from the insulating layer; and forming hard magnetic layers on remaining parts of the base layer, which are left on the both sides of the read-element.

In the method, the hard magnetic layers may be formed by diagonally sputtering with respect to a surface of a work piece so as not form a gap between the side face of the read-element and the hard magnetic layers. Further, in the method, a material, which crystal-grows the hard magnetic layer so as to orient a magnetizing direction of the hard magnetic layers parallel to a surface of the base layer, may be used for forming the base layer on the insulating layer. In this case, the hard magnetic layer is capable of effectively applying a bias magnetic field to the read-element.

By employing the magnetic head and the method of the present invention, the hard magnetic layer can be located closer to the read-element, so that the bias magnetic field of the hard magnetic layer can be effectively applied to the read-element. Therefore, magnetic data detection performance of the read-head can be improved, and the magnetic head, which has stable characteristics, can be produced.

### BRIEF DESCRIPTION OF THE DRAWINGS

Embodiments of the present invention will now be described by way of examples and with reference to the accompanying drawings, in which:

FIG. 1 is a sectional view of a magnetic head of an embodiment of the present invention;

FIGS. 2A-2E are explanation views showing production steps of the magnetic head of the embodiment;

FIGS. 3A-3D are explanation views showing further production steps of the magnetic head of the embodiment;

FIG. 4 is a plan view of a magnetic disk drive unit;

FIG. 5 is a perspective view of a head slider; and

FIG. 6 is a sectional view of the conventional magnetic head.

### DETAILED DESCRIPTION OF THE EMBODIMENTS

Preferred embodiments of the present invention will now be described in detail with reference to the accompanying drawings.

### (Structure of The Magnetic Head)

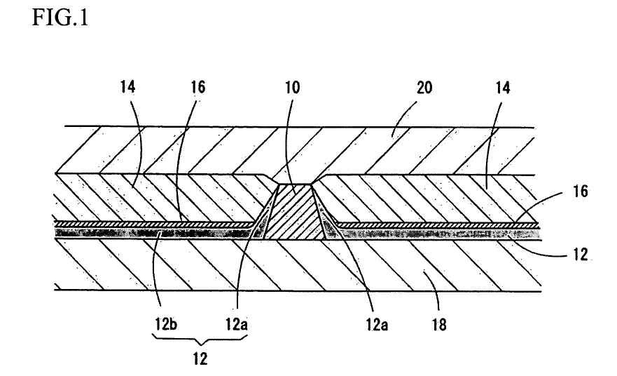

FIG. 1 is a sectional view of a read-head of a magnetic head of the present embodiment seen from an air bearing surface side. The basic structure of the read-head is the same as that of the conventional read-head shown in FIG. 6. Namely, a lower shielding layer 8 and an upper shielding layer 20 sandwich the read-element 10 in the thickness direction. Side faces of the read-element 10 and parts of the lower shielding layer 18, which outwardly extend from the read-element 10, are respectively coated with insulating layers 12. Hard magnetic layers 14 are respectively provided on the both sides of the read-element 10. The hard magnetic layers 14 apply bias magnetic fields to a free layer of the read-element 10 so as to make the free layer have a single domain structure.

The read-head of the present embodiment is characterized by base layers, which are used for forming the hard magnetic layers 14 and which are formed on the insulating layers 12. Namely, no base layers are formed on first parts 12a of the insulating layers 12, which respectively coat side faces of the read-element 10; base layers 16 are respectively formed on only second parts 12b of the insulating layers 12, which outwardly extend from the first parts 12a and coat a surface of a lower shielding layer 18.

Since the side faces of the read-element 10 are slope faces, the first parts 12a of the insulating layers 12 are inclined. The base layers 16 are outwardly horizontally extended from lower ends of the first parts 12a.

In the present embodiment, the first parts 12a of the insulating layers 12, which coat the side faces of the read-element 10, are not coated with the base layers 16, so the hard magnetic layers 14 are directly formed on the surfaces of the insulating layers 12. Therefore, the hard magnetic layers 14 can be located closer to the side faces of the read-element 10 due to no base layers 16.

In comparison with the conventional magnetic head, in which the first parts 12a of the insulating layers 12 are coated with the base layers 16 (see FIG. 6), bias magnetic fields of the hard magnetic layers 14 can be more strongly applied to a free layer of the read-element 10, in the present embodiment.

Thicknesses of the first parts 12a of the insulating layers 12, which respectively coat the side faces of the read-element 10, are 3-4 nm; thicknesses of the base layers 16 are about 5 nm. Since the thicknesses of the base layers 16 are nearly equal to the thicknesses of the first parts 12a of the insulating layers 12, distances between the read-element 10 and the hard magnetic layers 14 can be reduced by the thicknesses of the base layers 16. Therefore, intensities of the bias magnetic fields of the hard magnetic layers 14 can be increased. Since the intensities of the bias magnetic fields are varied by the distances to the read-element 10, said structure is effective. Namely, the magnetic head of the present embodiment is capable of effectively improving detection performance of the read-element 10.

### (Method of Producing The Magnetic Head)

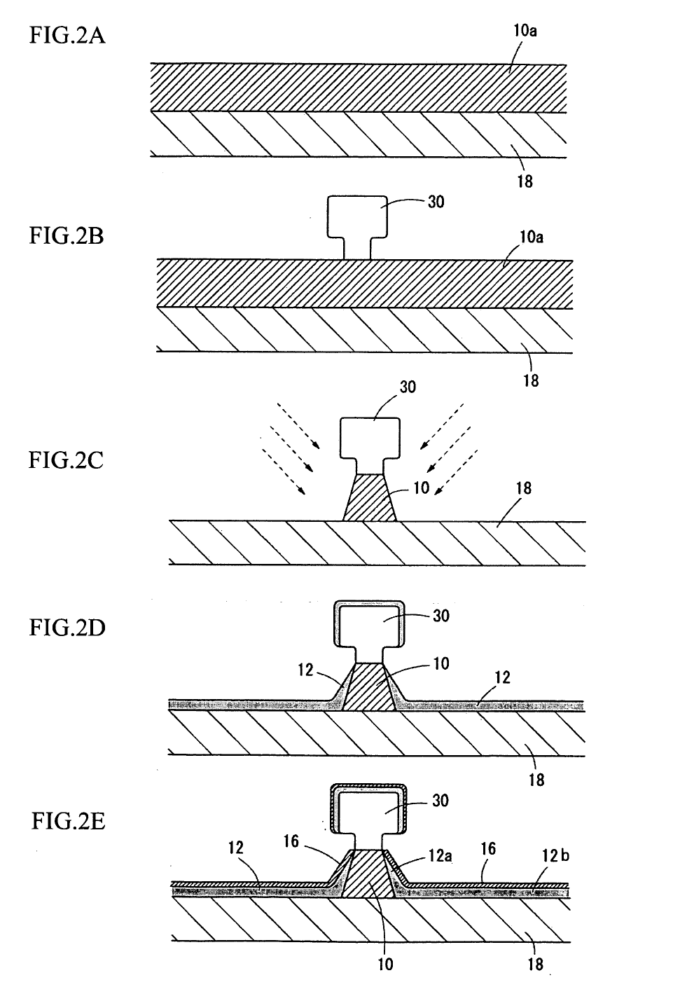

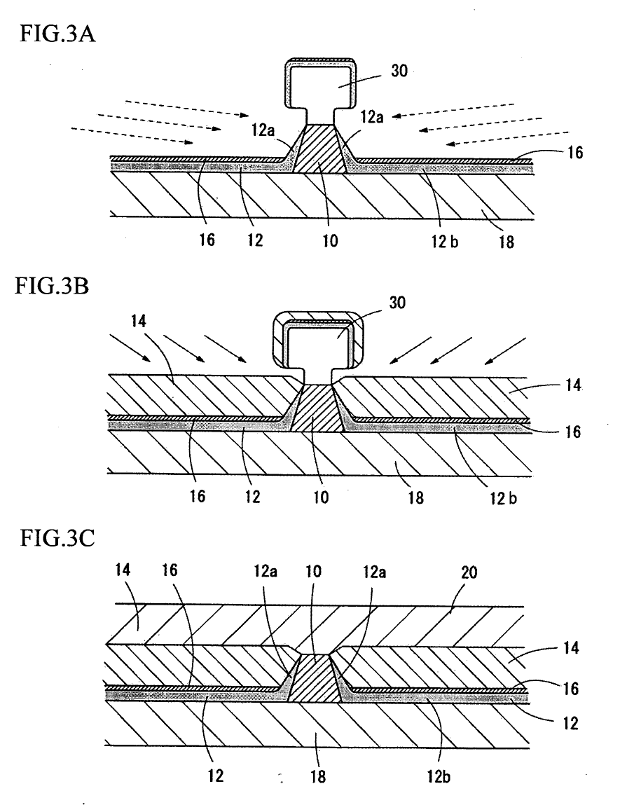

A method of producing the read-head of the magnetic head of the first embodiment will be explained with reference to FIGS. 2A-2E and FIGS. 3A-3C.

In FIG. 2A, the lower shielding layer 18 is formed on a AlTiCsubstrate, then a magnetoresistance effect film 10a, which will become the read-element 10, is formed on an entire surface of the lower shielding layer 18. The lower magnetic shielding layer 18 is made of a soft magnetic material, e.g., NiFe.

The magnetoresistance effect film 10a includes a pinned layer, whose magnetizing direction is fixed, and a free layer, whose magnetizing direction is varied by a magnetic field from a magnetic recording medium. The magnetoresistance effect film 10a further includes ferromagnetic layers, which constitute the pinned layer and the free layer, an antiferromagnetic layer for fixing the magnetizing direction of the pinned layer, and nonmagnetic layers. The layered structures are designed on the basis of products. Note that, the present invention is not limited to the magnetoresistance effect film 10a having said structure.

In FIG. 2B, photo resist is applied on the surface of the magnetoresistance effect film 10a, and the photo resist is patterned to form a mask pattern 30, which covers a part to be formed into the read-element 10. The two-layered resist, whose etching rates are different in the layers, is used. After etching the resist, a lower part of the mask pattern 30 is made thinner than an upper part thereof.

In FIG. 2C, the magnetoresistance effect film 10a is etched by ion-milled, and the read-element 10, whose sectional shape is like a trapezoid, is formed. Preferably, a work piece is diagonally ion-milled so as to approximate the inclination angles of the side faces to 90 degrees.

In FIG. 2D, the side faces of the read-element 10 and a surface of the lower shielding layer 18 are coated with the insulating layers 12. The insulating layers 12 are formed by, for example, sputtering alumina.

In FIG. 2E, the base layers 16 are respectively formed on the insulating layers 12. The base layers 16 are formed on at least the second parts 12b of the insulating layers 12, which outwardly extend from the side faces of the read-element 10. The base layers 16 are made of a material, which crystal-grows the hard magnetic layers 14 and orients the magnetizing directions of the hard magnetic layers 14 in the horizontal direction parallel to a plane of the free layer of the read-element 10, e.g., Cr, CrTi.

In FIG. 3A, parts of the base layers 16, which have been stuck on the first parts 12a of the insulating layers 12, are removed, so that the base layers 16 coat only the second parts 12b of the insulating layers 12, which coat the surface of the lower shielding layer 18.

To remove the parts of the base layers 16 from the first parts 12a of the insulating layers 12, ion milling is performed in the directions parallel to the surface of the work piece. Actually, the ion milling is performed at an angle with respect to the surface of the work piece. By this step, the parts of the base layers 16, which have been stuck on the first parts 12a of the insulating layers 12, are removed, so that the first parts 12a are exposed.

In FIG. 3B, the hard magnetic layers 14 are formed, by sputtering, after the parts of the base layers 16 are removed from the first parts 12a of the insulating layers 12. The hard magnetic layers 14 are made of a ferromagnetic material having a large coercive force, e.g., CoCrPt, CoPt.

The first parts 12a of the insulating layers 12 upwardly extended from the second parts 12b thereof, and the mask pattern 30 is formed on a top part of the read-element 10. With this structure, if the sputtering is vertically performed with respect to the surface of the work piece, the hard magnetic layers 14 are not formed on side base parts of the side faces of the read-element 10 and gaps are formed between the side faces of the read-element 10 and the hard magnetic layers 14. Preferably, the sputtering is diagonally performed with respect to the surface of the work piece so as to securely form the hard magnetic films 14 on the side base parts of the side faces of the read-element 10.

In FIG. 3C, the mask pattern 30 is removed after forming the hard magnetic layers 14, the mask pattern 30 is removed, and the upper shielding layer 20 is formed on the entire surface of the work piece. The upper shielding layer 20 is also made of a soft magnetic material, e.g., NiFe.

By the above described steps, the read-head shown in FIG. 1 can be produced. The parts of the base layers 16 are removed from the first parts 12a of the insulating layers 12, so that the hard magnetic layers 14 directly coat the surfaces of the first parts 12a of the insulating layers 12.

In the present embodiment, the side faces of the read-element 10 are inclined. Ideally, the side faces of the read-element 10 are vertically formed with respect to the surface of the substrate. In case of forming the side faces of the read-element 10 near-vertical with respect to the surface of the substrate, the hard magnetic layers 14 are formed on the base layers 16, which coat the second parts 12b of the insulating layers 12 formed on the lower shielding layer 18. Therefore, orientation characteristics of the hard magnetic layers 14 are controlled by the base layers 16 formed above the lower shielding layer 18. Even if the first parts 12a of the insulating layers 12 are not coated with the base layers 16, the control of the orientation directions of the hard magnetic layers 14 can be performed without difficulty.

The first parts 12a of the insulating layers 12 have prescribed thicknesses so as to ensure electric insulation. Therefore, a problem of electric short can be prevented.

### (Magnetic Disk Drive Unit)

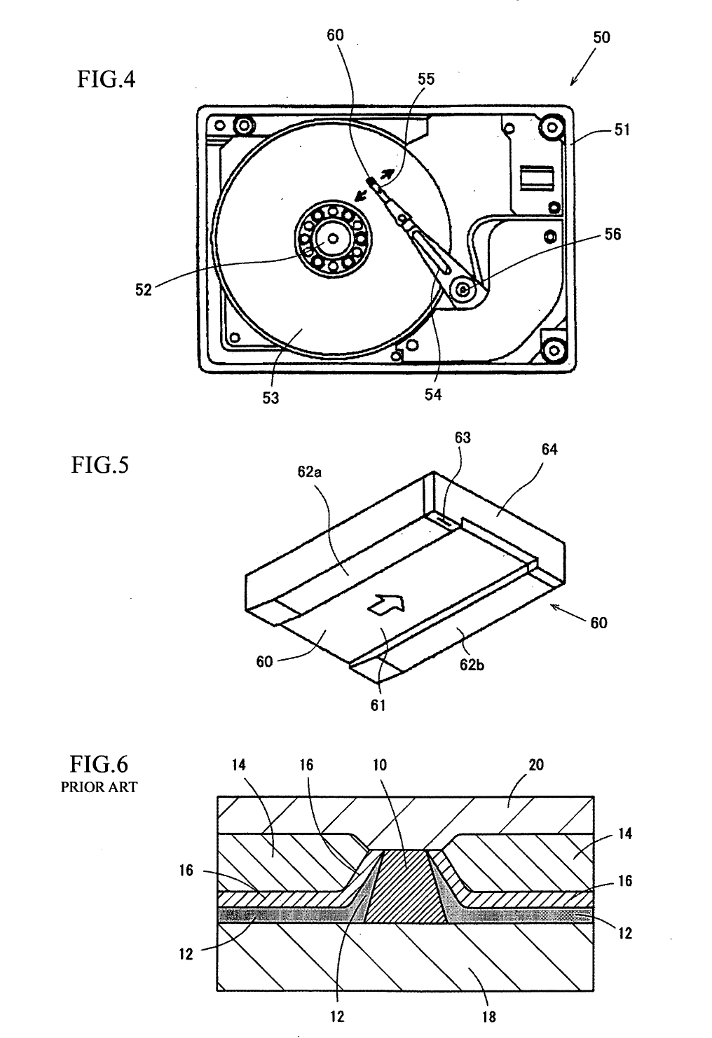

A magnetic disk drive unit having the magnetic head of the present invention is shown in FIG. 4. The magnetic disk drive unit 50 comprises: a rectangular box-shaped casing 51; a spindle motor 52 accommodated in the casing 51; and a plurality of magnetic recording disks 53 rotated by the spindle motor 52. Carriage arms 54, which can be swung in planes parallel to the surfaces of the disks 53, are located beside the disks 53. A head suspension 55 is attached to a longitudinal front end of each of the carriage arms 54. A head slider 60 is attached to a front end of the head suspension 55. The head slider 60 is attached to a disk side face of the head suspension 55.

FIG. 5 is a perspective view of the head slider 60. In an air bearing surface of the head slider 60 which faces the surface of the disk 53, floating rails 62a and 62b for floating the head slider 60 from the surface of the disk 53 are formed along side edges of a slider body 61. A magnetic head 63 having the above described read-head is provided to the front end side (the air-outflow side) of the head slider 60 so as to face the disk 53. The magnetic head 63 is coated and protected by a protection film 64.

When the magnetic disks 53 are rotated by the spindle motor 52, each of the head sliders 60 is floated from the surface of the disk 53 by air stream generated by the rotation of the disk 53, and then a seek action is performed by an actuator 56 so that data are written in and read from the disk 53 by the magnetic head 63.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head,
comprising:
a lower shielding layer;
a read-element being formed on said lower shielding layer;
an insulating layer continuously coating side faces of said read-element a surface of said lower shielding layer;
a base layer being formed on said insulating layer; and
a hard magnetic layer being formed on said base layer,
wherein parts of said insulating layer, which coat the side faces of said read-element, are coated with no base layer.

2. The magnetic head according to claim 1,
wherein said base layer is made of a material, which crystal-grows said hard magnetic layer so as to orient a magnetizing direction of said hard magnetic layer parallel to a surface of said base layer.

3. A method of producing a magnetic head,
comprising the steps of:
forming a lower shielding layer on a substrate;
forming a read-element on said lower shielding layer;
forming an insulating layer to continuously coat side faces of said read-element and a surface of said shielding layer;
forming a base layer on said insulating layer;
removing parts of said base layer, which correspond to the side faces of said read-element, from said insulating layer; and
forming hard magnetic layers on remaining parts of said base layer, which are left on the both sides of said read-element.

4. The method according to claim 3,
wherein said hard magnetic layers are formed by diagonally sputtering with respect to a surface of a work piece so as not form a gap between the side face of said read-element and said hard magnetic layers.

5. The method according to claim 3,
wherein a material, which crystal-grows said hard magnetic layer so as to orient a magnetizing direction of said hard magnetic layers parallel to a surface of said base layer, is used for forming said base layer on said insulating layer.
